(19) United States
(12) Patent Application Publication
(10) Pub. No.: US 2021/0316402 A1
(43) Pub. Date: Oct. 14, 2021

(54) PROCESS CONTROL METHOD FOR LASER MATERIAL PROCESSING

(71) Applicant: II-VI Delaware, Inc, Wilmington, DE (US)

(72) Inventor: Mathias Cornelißen, Birkenwerder (DE)

(21) Appl. No.: 17/301,574

(22) Filed: Apr. 8, 2021

(30) Foreign Application Priority Data
Apr. 9, 2020 (DE) 102020110087.6

(51) Int. Cl. B23K 26/70; B23K 26/03; B23K 1/005; B23K 26/24; B23K 26/38

(52) U.S. Cl. CPC B23K 26/705; B23K 26/032; B23K 26/38; B23K 26/24; B23K 1/0056

(57) ABSTRACT

The present invention relates to a method for process control in laser material processing and provides a method for process control and regulation in laser material processing, comprising generating at least two ST individual diagrams in the regions of interest of images of laser material processing and orienting the at least two ST individual diagrams in a previously determined pattern

### BACKGROUND OF THE INVENTION

### Field of the Invention

The invention relates a process control method for laser material processing.

### Brief Description of the Related Art

The use of lasers in materials processing is now a common and well-established process. As laser material processing has evolved, many different processes are possible today, ranging from surface processing, cutting and joining to the targeted manipulation of materials and their surfaces.

The diversification of processes that are possible using a laser is accompanied by an increase in the range of materials that can be processed today. This results in increasing and more complex requirements for process control of the now possible processes, since the process window in which good results are achieved is becoming smaller and smaller. To achieve an acceptable result, only minimal deviations are possible in laser material processing.

It is therefore necessary to have a method at hand, which allows accurate monitoring of the process of laser material processing.

Published international patent application number WO 2013/053832 A1 discloses a device in which backscattered light is measured in a laser cutting process to verify cut quality. The measured intensity of the backscattered light is lower when the cut actually extends through the workpiece. To optimize the removal of slag, the frequency or pressure of gas pulses used in the cutting process are adjusted by a control device so that the measured intensity of backscattered light assumes a minimum value. The general cause of a cut break is insufficient energy input into the workpiece. The insufficient energy input leads to a flattening of the cutting front, i.e. to an increase in the cutting front angle, as a result of which the melt can no longer be completely expelled at the bottom edge of the cut and solidifies in the kerf. The closure of the bottom edge of the cut leads to process irregularities, which usually permanently prevent a separation cut. The cutting front angle, which is a characteristic parameter of the kerf, is therefore an indicator of impending kerf breakage

In the published international patent application with the file number WO 2012/107331 A1, it is proposed to detect a cutting front upper edge and a cutting front lower edge as the material boundary of the workpiece and to determine the cutting front angle of the laser cutting process from this, taking into account the thickness of the workpiece. For this purpose, the distance between the upper edge of the cutting front and the lower edge of the cutting front along the center of the kerf or kerf is typically measured in the visible wavelength range. If the cutting front angle deviates from a nominal value or a nominal range, this may indicate a cutting error or a non-optimal operating point, which can be corrected by suitable measures, e.g. by adjusting the cutting speed.

In the case of coaxial process observation through the cutting nozzle, both for the observation of temperature radiation, backscattered high-energy radiation and for the observation of material boundaries, there is the problem that the observation area is limited by the usually circular inner contour of the cutting nozzle. In particular, small nozzle diameters are used in flame cutting processes, so that the lower edge of the cutting front lies outside the observation range limited by the nozzle mouth, even in the case of a credit cut, and the cutting front angle cannot be reliably determined.

The published German patent application DE 10 2011 016 519 A1 describes a method and a device for controlling the machining of a workpiece by means of a high-energy machining beam, in which the machining beam passes through a lens that can be moved perpendicular to its optical axis to shift an impact point of the machining beam on the workpiece. In one example, a surveillance camera is provided for generating an electronically analyzable image whose imaging beam path is focused through the lens onto the point of impingement.

The published European patent application with the reference EP 3 043 951 B1 discloses a device for monitoring, in particular for controlling, a cutting process on a workpiece, comprising a focusing element for focusing a high-energy beam, in particular a laser beam, onto the workpiece, an image acquisition device for detecting an area on the workpiece which is to be monitored, which comprises a region of interaction of the high-energy beam with the workpiece, and an evaluation device which is designed to determine at least one characteristic parameter of the cutting process, in particular of a kerf formed during the cutting process, on the basis of the detected region of interaction, the image acquisition device being designed to form an observation beam for observing the interaction region from an observation direction running at an angle to the beam axis of the high-energy beam, and the image acquisition device comprising imaging optics for generating an image of the interaction region from the observation direction (R1) running at the angle to the beam axis of a high-energy beam, characterized in that the observation direction runs in a plane (X, Y) perpendicular to the beam axis of the high-energy beam counter to a feed direction of the cutting process, and in that the evaluation device is designed to use the detected interaction region to determine a cutting front angle of the kerf and/or an overshoot and/or an undershoot of a predetermined cutting front angle of the kerf as characteristic parameter(s) of the cutting process.

The object of the present invention is to provide an improved process control method for laser material processing.

### SUMMARY OF THE INVENTION

The present invention provides a method for process control and regulation in laser material processing, comprising generating at least two ST individual plots in the regions of interest of images of laser material processing and orienting the at least two ST individual plots in a predetermined pattern.

In a further aspect, the method according to the invention may comprise arranging the ST individual diagrams as a central cross through the tool tip, over leading and trailing, to the right or left of the feed direction or at a previously defined distance from the working process.

It may be provided in a further embodiment of the invention that at least two crosses of ST individual diagram are arranged parallel to a grid.

It is further provided according to the invention that before generating the at least two ST individual diagrams, the following steps are performed:
a. Acquisition of images with an area sensor sensitive in the mid-infrared wavelength range, wherein the area sensor is fixed aligned coaxially to the laser beam axis;
b. Determination of regions of interest in the captured images according to at least one of the following parameters selected from the group comprising the, the input variable feed direction of the device for laser material processing from its memory programmable control, the evaluation of image information regarding the determination of a feed vector and the evaluation of image information rotating around the tool tip;
c. Rotation of the geometry to generate the S-T diagrams, given by the direction vector, for omnidirectional evaluation.

The method according to the invention may comprise the following steps after generating the at least two ST individual diagrams:
e. Evaluation of previously determined features from the image information of the ST individual diagrams by analyzing the information of the ST individual diagrams and by comparing the information from the at least two ST individual diagrams;
f. Evaluation of the overall image according to at least one geometric parameter selected from the group comprising the tool tip and the process tail and the process vector derived therefrom, intensity variations, melt pool geometry and symmetry, the piercing and the kerf;
g. Evaluation of the intensity signals of the sensor.

In another aspect of the invention, the evaluation of the intensity signals from the sensor includes determining maximum and minimum values.

In a further embodiment, it may be provided that the images are captured at a frame rate of at least 1,000 fps.

In addition, it is envisioned that the images will be captured in a wavelength range of 1,000-5,000 nm.

The method according to the invention can determine features in a cutting, welding or brazing process from at least two ST individual diagrams selected from the group comprising:
in welding: the formation of the weld pool geometry, the formation of spatter from the weld pool, the bond, and the seam location;
when cutting: the formation of the kerf, the curvature of the kerf front, the formation of a hole in the material;
in soldering: the beam-wire adjustment, the melting behavior of the wire, the melt pool geometry, and the connection from the solder to the metal to be joined;
for all previously mentioned methods also the laser power, the focus position, the focus diameter and beam shaping.

In a further aspect, the method according to the invention provides for the images to be captured by at least one deflection mirror.

Furthermore, the method according to the invention may comprise the step concerning a control of the laser material processing. This step may also be the final step of the method according to the invention.

The method provides for influencing the following parameters for the steps of laser material processing control:
when welding oscillation frequencies and amplitudes;
when cutting from gas pressure;
when soldering from the filler metal and beam-wire alignment;
generally the laser power, relative process speed, focus position in all three dimensions and/or the focus diameter and further beam shaping

Furthermore, in one embodiment, it may be provided that information from the laser material processing control system is also used for evaluation, so that deviations from the planned location of the laser material processing are detected and/or corrected.

Other aspects, features and advantages of the present invention will readily be apparent from the following detailed description, which simply sets forth preferred embodiments and implementations. The present invention may also be realized in other and different embodiments, and its various details may be modified in various obvious aspects, without departing from the teachings and scope of the present invention. Accordingly, the drawings and descriptions are to be considered illustrative and not limiting. Additional purposes and advantages of the invention are set forth in part in the following description and will become apparent in part from the description or may be inferred from the embodiment of the invention.

### SUMMARY OF THE DRAWINGS

The invention is described in more detail below with the aid of drawings. It is obvious to the person skilled in the art that these are only possible, exemplary embodiments, without limiting the invention to the embodiments shown. The scope of protection is defined by the claims and the underlying teaching and the resulting equivalents. For the person skilled in the art, it follows that features of one embodiment may also be combined with features of other embodiments shown or described, wherein:

FIG. 1 shows an image in which the dashed lines indicate the plane and arrangement of the at least two ST individual diagrams.

FIG. 2 shows, for an omnidirectional function, a moving (rotating) crosshair of ST individual graphs.

FIG. 3 shows the arrangement of ST individual diagrams into a parallel grid for process control.

### DETAILED DESCRIPTION OF THE INVENTION

The previously formulated object of the invention is solved by the features of the independent claims. The dependent claims cover further specific embodiments of the invention.

In the context of the present invention, the term laser material processing is intended to mean the following processes (cf. Bliedtner, Müller, Barz, Lasermaterialbearbeitung, Grundlagen-Verfahren-Anwendungen-Beispiele, ISBN 978-3-446-42168-4):

1. Ablative and separative processes:
i. Cutting,
ii. Clean,

2. Melting and property-changing processes:
i. Fügen:
   a) Welding,
   b) Soldering
ii. Surface treatment,

3. Applying and generating processes:
i. Generative processes:
   a) Stereolithography,
   b) Laser sintering,
   c) Direct Energy Deposition.
      For the sake of simplicity, generative processes are included with welding processes.

The term process control and regulation is also synonymously referred to as monitoring in the context of the present invention.

The present invention is based on the coaxial integration of an area sensor sensitive in the spectral range of 1-5 μm, which is capable of monitoring dynamic laser processes at frame rates higher than 300 Hz and simultaneously controlling them with respect to various features via downstream image processing. The different features are process and partly product specific. The features are evaluated in combination of image-based evaluation as well as by a globally acquired temperature signal. Furthermore, depending on the resolution of the sensor, a process control by actively influencing laser power, focus position and focus diameter is aimed at.

If the laser material processing involves cutting material, monitoring of the nozzle centering, the condition of the cutting nozzle and the selection of the correct nozzle diameter is also provided as part of the process control.

Furthermore, monitoring and control of so-called piercing processes are planned, in particular their temporal duration and quality. The piercing process is recorded continuously at 1000 fps (frames per second). For the detection of the piercing process or its termination, the use of a thermographic camera offers the following two possibilities:
1. Evaluation of the maximum signal over all pixels. The end of the piercing can be detected by a drop in the maximum intensity. This also works reliably defocused at usual piercing distances, whereby the focus of the camera is not readjusted.
2. Evaluation of the image information, the formation of the hole can be clearly seen in the camera image and is most evident in the focus.
   The combination of the two possibilities is also provided for obtaining according to the invention.

Furthermore, omnidirectional monitoring of cutting processes is provided for features such as kerf stability, keyhole width, cut front length, in order to be able to generate statements about the quality of the cut. By evaluating the maximum signal over all pixels, it can be determined that the maximum intensity increases significantly in the case of an incomplete cut. When evaluating the image information, the formation of the kerf can be detected well and, in addition, a tear-off of the kerf can be detected. Here, too, the combination of evaluation of the maximum intensity and the image information leads to a reliable result in terms of process control of the cutting process, which then also allows direct intervention in the control of cutting parameters such as the laser power, the focus position, the focus diameter, the cutting speed and the gas pressure.

Furthermore, an evaluation for the assessment of the cut front, the symmetry of cut edges and the heat input into the component is also provided. Through a connection with the machine control and the associated knowledge about the course of the kerf, the system can detect vibrations of the system as well as of the cutting bed and report these as errors.

In welding processes, the direct evaluation and processing of partial aspects of the recordings also enables conclusions to be drawn about the process. Here, too, the information obtained can be used to control the process parameters. When evaluating welding processes, the parameters that play a role are the characteristics and dynamics of the steam flare typical of welding and any spatter that occurs. Also of interest are the shape and form of the weld seam, and in particular any inhomogeneity and bonding defects that occur. The position of sheet edges and thus the position of the weld seam relative to the sheet edge can also be evaluated, enabling seam tracking to be monitored.

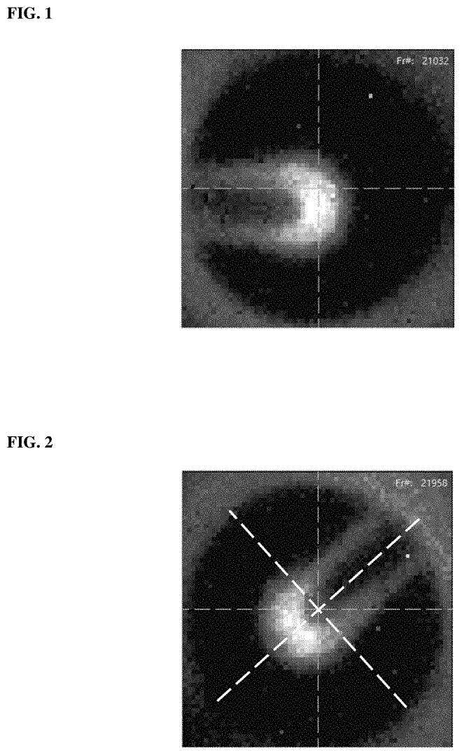

The present invention is based on the fact that at least two ST individual graphs are generated as part of the image evaluation, and these two ST individual graphs are arranged or placed as a cross over a region of interest, for example the focus position (synonymously as the position of the tool tip, or simply tool tip) (FIG. 1). These show the time evolution of the signal provided by a row and a column (selected by the crosshairs).

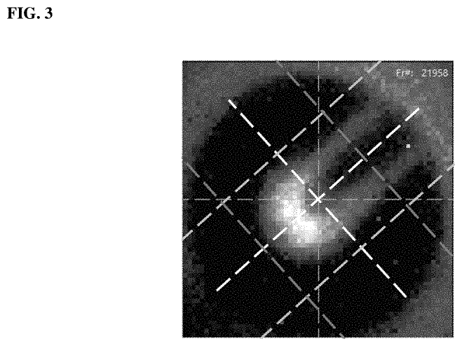

It is further provided according to the invention that a plurality of ST individual diagrams arranged as a cross are arranged to form a grid (FIG. 3), in which the crosses are arranged in parallel around a region of interest. According to the invention, the crosshairs as the center of the arrangement of ST individual diagrams can also move, e.g., rotate along a feed vector (FIG. 2). The same applies to a grid, which can also be moved along a feed vector.

The use of the at least two ST individual diagrams leads to a higher quality in the evaluation of the image information and thus allows a much more precise monitoring of the process control.

The foregoing description of the preferred embodiment of the invention has been given for the purpose of illustration and description. It is not intended to be exhaustive or to limit the invention precisely to the disclosed form. Modifications and variations are possible in view of the above teachings or may be obtained from practice of the invention. The embodiment has been chosen and described to explain the principles of the invention and its practical application to enable those skilled in the art to use the invention in various embodiments suitable for the particular use intended. It is intended that the scope of the invention be defined by the appended claims and their equivalents. The entirety of each of the foregoing documents is incorporated herein by reference.

1. A method for process control and regulation in laser material processing, comprising generating at least two ST individual diagrams in the regions of interest of images of laser material processing and orienting the at least two ST individual diagrams in a predetermined pattern.

2. The method according to claim 1, wherein the ST individual diagrams are arranged as a central cross through the tool tip, over leading and trailing, to the right or left of the feed direction or at a previously defined distance from the working process.

3. The method of claim 2, wherein at least two crosses of ST single diagram are arranged parallel to a grid.

4. The method of claim 1, wherein prior to generating the at least two ST individual plots, the following steps are performed:
a. Acquisition of images with an area sensor sensitive in the mid-infrared wavelength range, wherein the area sensor is fixed aligned coaxially to the laser beam axis;
b. Determination of regions of interest in the captured images according to at least one of the following parameters selected from the group comprising the, the input variable feed direction of the device for laser material processing from its memory programmable control, the evaluation of image information regarding the determination of a feed vector and the evaluation of image information rotating around the tool tip;
c. Rotation of the geometry to generate the S-T diagrams, given by the direction vector, for omnidirectional evaluation.

5. The method of claim 1, wherein after generating the at least two ST individual plots, the following steps are performed:
e. Evaluation of previously determined features from the image information of the ST individual diagrams by analyzing the information of the ST individual diagrams and by comparing the information from the at least two ST individual diagrams;
f. Evaluation of the overall image according to at least one geometric parameter selected from the group comprising the tool tip and the process tail and the process vector derived therefrom, intensity variations, melt pool geometry and symmetry, the piercing and the kerf;
g. Evaluation of the intensity signals of the sensor.

6. The method of claim 5, wherein evaluating the intensity signals of the sensor comprises determining maximum and minimum values.

7. The method of claim 1, wherein the images are captured at a frame rate of at least 1,000 fps.

8. The method of claim 1, wherein the images are acquired in a wavelength range of 1,000-5,000 nm.

9. The method of claim 1, wherein, in a cutting, welding, or brazing process, features selected from the group consisting of at least two ST individual diagrams are determined:
in welding: the formation of the weld pool geometry, the formation of spatter from the weld pool, the bond, and the seam location;
when cutting: the formation of the kerf, the curvature of the kerf front, the formation of a hole in the material;
in soldering: the beam-wire adjustment, the melting behavior of the wire, the melt pool geometry, and the connection from the solder to the metal to be joined;
In all the above-mentioned methods, the laser power, the focus position, the focus diameter and beam shaping.

10. The method according to claim 1, wherein a recording of the images is performed by at least one deflection mirror.

11. The method of claim 1, concluding with the step of controlling laser material processing.

12. The method of claim 11, wherein the steps of controlling the laser material processing include influencing:
a. when welding oscillation frequencies and amplitudes;
b. when cutting from gas pressure;
c. when soldering from the filler metal and beam-wire alignment;
d. generally the laser power, relative process speed, focus position in all three dimensions and/or the focus diameter and further beam shaping includes.

13. The method according to claim 1, wherein information from the control of the laser material processing is also used for evaluation, so that deviations from the planned location of the laser material processing are detected and/or corrected.
